(19) United States
(12) Patent Application Publication
(10) Pub. No.: US 2025/0024005 A1
(43) Pub. Date: Jan. 16, 2025

(54) REAL TIME MASKING OF PROJECTED VISUAL MEDIA

(71) Applicant: Vladimir V. Maslinkovskiy, Parkland, FL (US)

(72) Inventor: Vladimir V. Maslinkovskiy, Parkland, FL (US)

(21) Appl. No.: 18/222,211

(22) Filed: Jul. 14, 2023

(51) Int. Cl. H04N 9/31; G06T 7/11; G06T 7/70

(52) U.S. Cl. CPC H04N 9/3179; G06T 7/11; G06T 7/70; H04N 9/3141; G06T 2207/10028; G06T 2207/10048; G06T 2207/30196

(57) ABSTRACT

A projection system projects in an image field, and a sensor is used to detect and recognize an object in the image field of the projector. Upon detecting the object in the image field, a mask is generated that corresponds to the region of the object in the image field of the projector, and the mask is applied to a source video to produce a modified source video that is projected by the projector. The mask causes the light in the region of the object in the image field of the projector to be modified from that of the source video.

### FIELD OF THE INVENTION

The present invention relates generally to media projection systems, and, more particularly, relates to a media projection system which identifies the position of a real person in front of a screen on which the visual media is being projected, and which masks off the media in the location of the person so that media is not projected onto the person, and which can detect movement of the person to alter or control the projected media content.

### BACKGROUND OF THE INVENTION

Projection systems are in widespread usage and are popular in a number of fields. Because projection allows for the display of a large image that can be seen from a distance, they provide a relatively inexpensive means of displaying information for large groups and at distances that are not suitable for LED displays that would cost the same as a projection system. Of course, projection display systems have their own challenges, one of which is brightness. Because the light is projected onto a surface, people can walk into the light being projected. Because of this, the brightness level of projection display systems is kept to a level that will not cause injury to the eye. Another problem with projection display systems is that, even when the brightness is properly controlled to prevent injury, it is still quite bright, and a person standing in the image field, such as when given a speech about the subject matter being presented, can experience difficulty seeing the audience or other people present.

Therefore, a need exists to overcome the problems with the prior art as discussed above.

### SUMMARY OF THE INVENTION

In accordance with some embodiments of the inventive disclosure, there is provided a video projection system that incudes a projector that is configured to project video onto a surface in an image field. There is also included at least one camera having a camera view which includes the image field of the projector and that produces image data of the camera view. There is also an image processor coupled to the projector and the at least one camera that recognizes an object in the image data that is in the image field of the projector, and which generates a mask that is applied to a source video to create a modified video that is projected by the projector, wherein the projector changes light being projected in a region of the mask in the modified video relative to the source video.

In accordance with a further feature, the projector changes the light being projected in a region of the mask by reducing a brightness of the light being projected in the region of the mask relative to what would have been projected using the source video.

In accordance with a further feature, the light is blacked out in the region of the mask.

In accordance with a further feature, the projector changes the light being projected in a region of the mask by projecting a graphic overlay in the region of the mask instead of the portion of the source video that corresponds to the location of the mask in the image field.

In accordance with a further feature, the at least one camera includes at least two cameras.

In accordance with a further feature, the at least one camera includes a visible light camera.

In accordance with a further feature, the at least one camera includes an infrared camera.

In accordance with a further feature, the at least one camera includes a time of flight camera.

In accordance with a further feature, there is also included a non-light sensor that transmits a signal and senses a return signal that indicates a location of the object.

In accordance with some embodiments of the inventive disclosure, there is provided a video projection device that includes a projector operable to project a video in an image field, and a sensor operable to generate an image that includes the projected image field of the projector. There is also an image processor responsive to the sensor that is configured to detect process the image generated by the sensor, detect an object in the image field of the projector, and generate a mask corresponding to the object in the image field of the projector. The mask is applied to a video source to produce a modified video source that is projected by the projector wherein light in the region of the mask is modified from that of the video source.

In accordance with a further feature, the sensor is at least one camera.

In accordance with a further feature, the projector and the image processor are integrated into a housing.

In accordance with a further feature, the sensor is integrated into the housing.

In accordance with a further feature, the sensor is connected to the housing via a cable.

In accordance with a further feature, the sensor includes a non-light sensor.

In accordance with some embodiments of the inventive disclosure, there is provided a method of modifying a source video for projection that includes identifying an image field of a projector, detecting an object in the image field of the projector, determining a location of the object in the image field of the projector, generating a mask that corresponds to the location of the object in the image field, applying the mask to a source video to produce a modified source video in which content in the region of the mask is modified, and projecting the modified source video.

In accordance with a further feature, detecting an object in the image field comprises detecting the object in an image taken by a camera that includes the image field and recognizing the object in the image field in the image taken by the camera.

Although the invention is illustrated and described herein as embodied in a projection device, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the article being referenced. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1A shows a prior art projection system from a side view.

FIG. 1B shows the prior art projection system from a front view, looking toward the projected image.

FIG. 2 shows a projection system having real time object recognition and masking, in accordance with some embodiments.

FIG. 3 shows a camera view of a projected image field including an object that is at least partially in the image field, in accordance with some embodiments.

FIG. 4 shows a processing result of identifying a portion of the object that is in the projected image field, in accordance with some embodiments.

FIG. 5 shows a view of the object from the perspective of the projector, in which a portion of the source image being projected that corresponds to the object in the image field is masked, in accordance with some embodiments.

FIG. 6 shows a process diagram indicating how a projection system identifies an object in a projected image field and generates a mask to change the light being projected onto the object, in accordance with some embodiments.

FIG. 7 shows a flowchart diagram of a method for recognizing an object in a projected image field and generating a mask to change the light that is projected onto the object, in accordance with some embodiments.

FIG. 8 shows a detail of the object recognition and mask generation process, in accordance with some embodiments.

FIG. 9 shows a multi-camera system for recognizing an object in a projected image field for generating a mask to change the light being projected on the object, in accordance with some embodiments.

FIG. 10A shows a projection device having an integrated camera system that detects objects in a projected image field of the projection device and which changes the light being projected onto the object by the projection device.

FIG. 10B shows a projection device having an attached camera system that detects objects in a projected image field of the projection device and which changes the light being projected onto the object by the projection device.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

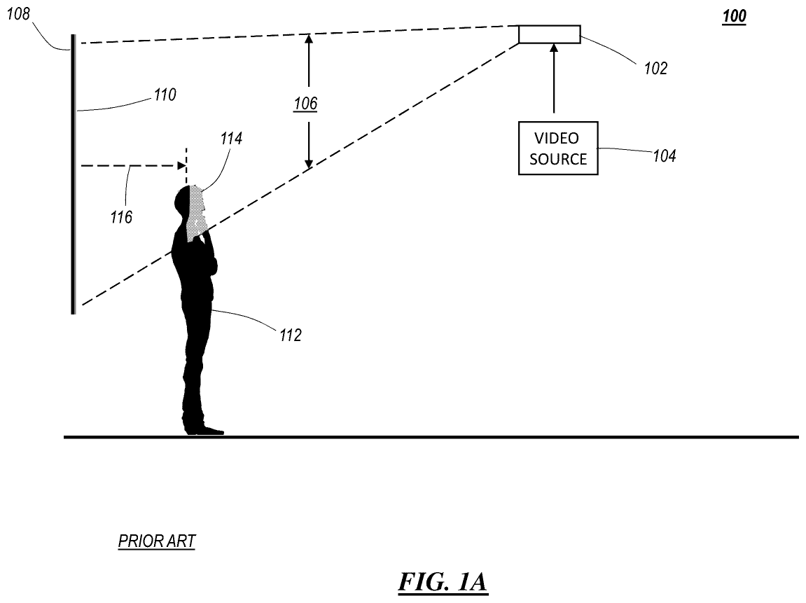

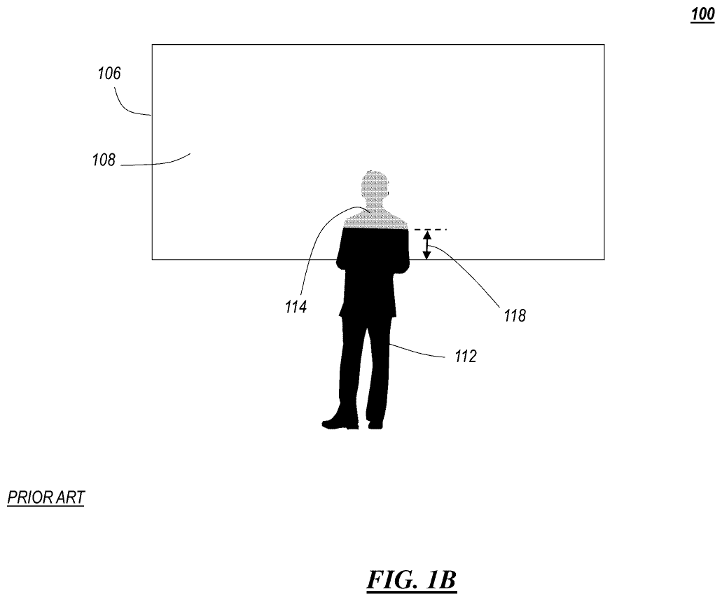

FIG. 1A shows a prior art projection system 100 from a side view. The projection system includes a projector 102 that projects an image onto a surface 108. Light from the projector is incident on the front side 110 of the surface 108. The surface 108 can be a wall, a screen, or any other suitable surface for image projection. The light being projected by the projector 102 creates an image field 106 in which light for the image being projected is evident. The image field 106 is largest at the surface 108. The image field reduces in area and size proportionally in a direction from the surface 108 to the projector 102. It should be appreciated that while the term “image” is used herein, the projector can be projecting static image content as well as video content. The “image” being projected can change from instant to instant. The image being projected can come from a video source 104, such as a media player, a computer, a television signal, a game console, and so on. Further, the term “image field’ refers to the area, from the perspective of the projector, in which an image is projected. The image field is largest at the surface 108 and smallest at the projector and passes through the space between the projector and the surface.

As is common in projection systems, a person 112 is shown standing partially in the image field 106 projected by the projector 102. More generally, the person 112 is an object that is at least partially in the image field, 106, and as a result, some of the image 114 being projected by the projector 102 is incident on the person 112. This a very common occurrence and happens every time a person walks in front of a projector. The amount (114) of the person 112 being illuminated by the image being projected can depend on how far the person 112 is from the surface 108, which is also indicative of how close they are to the projector 102, based in the angle of projection. In the example shown here, if the person 112 were to move sufficiently toward the projector 102 then there would be no light from the project incident on the person 112. Thus, the person's position relative to the projector can dictate how much of the image field is incident on them. In FIG. 1B, in an elevational view of the surface 108, looking from the direction of the projector 102, it can be seen that the region 114 of the person 112 that is illuminated by the projector does not appear to extend to the bottom of the image field 106 at the surface 108. This is because the view of FIG. 1B is taken from a different location that is below the projector and because the person 112 is closer to the projector than is the surface 108.

FIG. 1B shows the prior art projection system from a front view, looking toward the projected image.

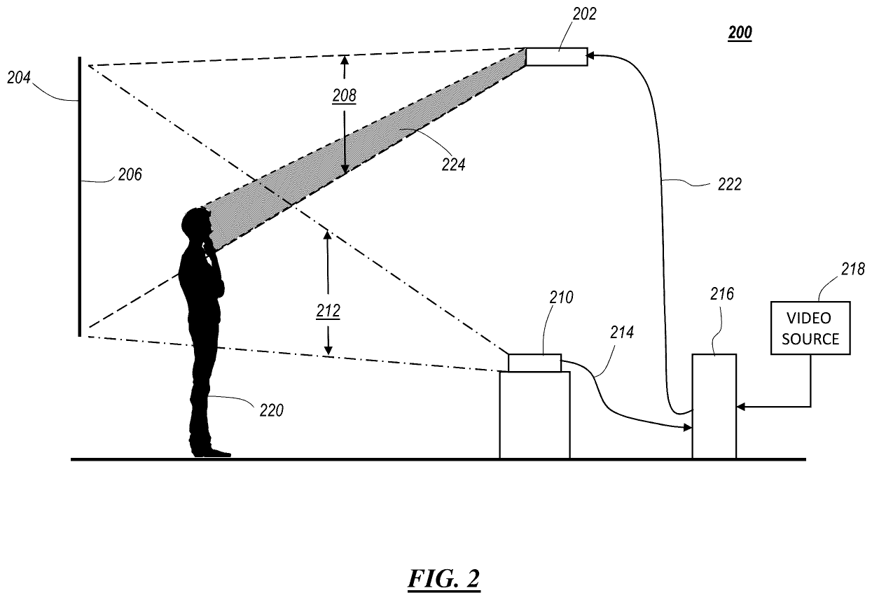

FIG. 2 shows a projection system 200 having real time object recognition and masking, in accordance with some embodiments. In general, the system 200 detects objects in the image field 208 of the projector 202, and can change the light being projected by the projector onto the recognized object(s). The light can be changed by reducing the light, projecting no light, or projecting a different image or image portion than a source image that would otherwise be projected onto the object.

The projector 202 projects an image field 208 onto a surface 206 of some physical barrier 204. In the present example, a person 220 is standing partially in the image field 208. A prior art projector system would also be projecting light on the portion of the person 22 that is in the image field 208 of the projector. However, the system 200 prevents that by changing the projected image in the region 224 of the projected image that falls on the person 220. The region 224 is the result of applying a mask to that portion of the image that falls within the region 224. The mask can suppress light, dim the light, or project a different image in the region 224.

The masking is accomplished by contemporaneously using a camera 210 to evaluate the image field 208 of the projector 202. Image data produced by the camera 210, which can be frames of video, is evaluated to determine if there is an object, such as person 220, in the image field 208, and if there is an object in the image field 208, where is the object located in the image field 208, i.e. from perspective of the projector 202. When the location of the object in the image field 208 is determined, then a mask can be generated that is used to modify the image data from a video source 218. The mask can define specific pixels in an image being, or to be projected, that are subject to change upon actually being projected. Thus, the camera 210 provides image data via connection 214 to an image processor 216. The image processor 216 is a computing device adapted to processing image data from the camera to recognize objects in the image field 208, and to modify image data from the video source 218 to create modified image data that is then provided to the projector via connection 222. The camera 210 has a view field 212 that is from a different location that the location of the projector 202. As a result, the difference in location must be taken into account by the image processor 216 in generating the mask information.

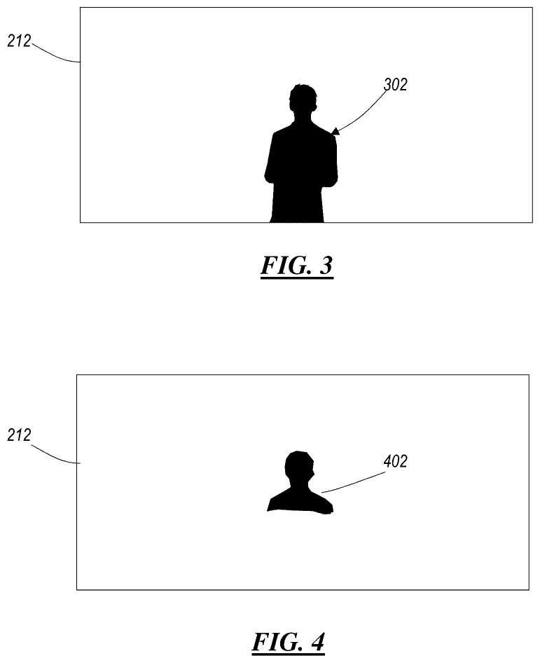

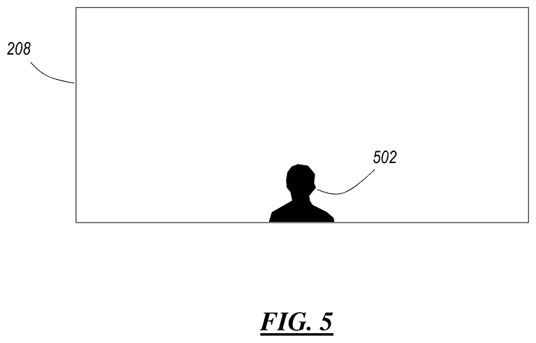

FIG. 3 shows, continuing the example of FIG. 2, a camera view 212 of a projected image field 208 including an object 302 that is at least partially in the image field 208, in accordance with some embodiments. At the surface 206 the image field 208 of the projector 202 has a known location in the camera view 212. That is, for example, a rectangular area where the projected image falls on the surface 206 is mapped to the corresponding location in the camera view 212 as a reference. This helps the image processor 216 determine how to map the generated mask region to the image being projected. Because the camera 210 is offset in space from the projector 202, the camera view 212 can include objects and portions of the person (object) 220. In particular, a larger portion 302 of the person 220 is in the camera view than is in the image field. As a result, as shown in FIG. 4, a smaller portion 402 of the person 220 is actually in the image field 208. In addition to recognizing the object in the image field, the image processor 216 can use image data to determine where in the image field the object is located. This is accomplished by taking into account the difference positions of the projector 202 and the camera 210 relative to the image field at the surface 206, as well as the position of the object relative to the surface 206 or the projector 202. A mapping operation is then used to map the edges of the object to their positions in the image being projected. In particular the edges of the object in the camera view image data are mapped to pixel locations in the image field being projected by the projector 202 to create an adjusted source image, as shown in FIG. 5. In FIG. 5, and mask region 502 in the image field 208 has been produced by the image processor 216. The portion of the source video that falls within the mask region 502 is changed by the image processor 216 to create the adjusted source data. Pixels within the mask region 502 can be shut off (blacked out), dimed, changed to a selected color, or changed to be another image. For example, for a person facing away from the surface 206 in the image field, an image of a costume can be projected on to them by fitting a costume image into the mask region 502. Several sprites of costume data can be defined to account for a person turning to the side, facing away from the projector, etc. In other applications, because the mask region 502 can simply be blacked out to avoid blinding a person standing in the image field, the rest of the image outside of the mask region 502 can be projected at a higher brightness that would be done with a prior art projector system.

In FIG. 2 a single conventional visible light optical camera 210 is shown and used to generate image data that can be processed to using optical recognition techniques to identify objects in the image field of the projector 202. It will be appreciated by those skilled in the art that although the process can be performed using only a single such camera, additional cameras and additional camera types can be used to generate additional image data that can augment the accuracy and speed of object recognition and object boundary definition for mask generation. This is especially true when using training models, for example, for object recognition.

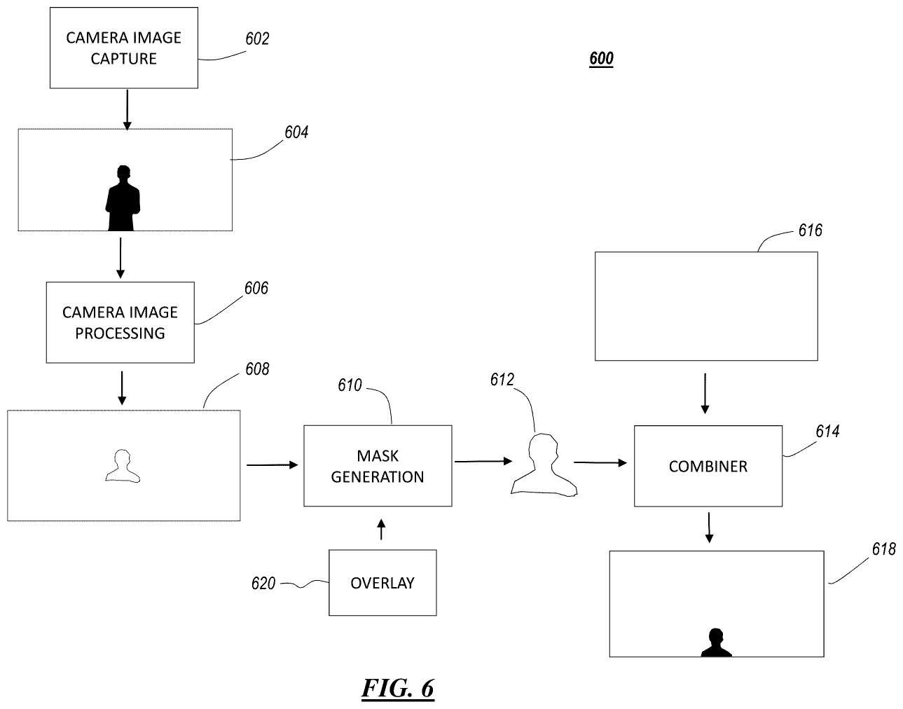

FIG. 6 shows a process diagram 600 indicating how a projection system identifies an object in a projected image field and generates a mask to change the light being projected onto the object in the projected image field, in accordance with some embodiments. The camera image capture process 602 produces a stream of images 604 that include the image field and any objects in the image field of the projector. A camera image processing function 606 is performed to recognize any objects in the image field of the projector, and the portion of the object in the image field, producing an output 608 in which the location of the object in the image field of the projector, as well as its position relative to the projector is identified in the camera view. Thus, the output 608 can include three dimensional metadata that describes the object recognized in the camera view. A mask generation function 610 then creates a mask 612 that corresponds to the portion of the object in the image field of the projector. The mask 612 can identify, for example, pixel locations in the projector's image field. A combiner function 614 then takes new source image data from the video source being projected and modifies it with the mask 612 to create a masked image 618 that is projected with the mask 612 corresponding to the location of the object in the projector's image field. As a result, the light projected onto the object is changed from what it would have been if the projector had projected the source image 616. The masked image 618 is provided to the projector rather than the raw source image 616. As mentioned, the mask 612 can be used to reduce light, eliminate light (black out), change to a uniform color, or project some other image in the region of the mask 612 in the projector's image field. For example, an overlay 620 can be a color or an image that is mapped into the mask 612. Thus, the mask data going to the combiner function 614 can include color information on a pixel by pixel basis. This can allow, for example, a person standing in the image field to appear to be wearing a costume, make-up, etc. The overlay 620 will continue to be projected over the object while the source video is projected around the object, and it will appear to people watching the projected video that the person or object is a part of the source video. This operation can be used, for example, for gaming and other recreational activities.

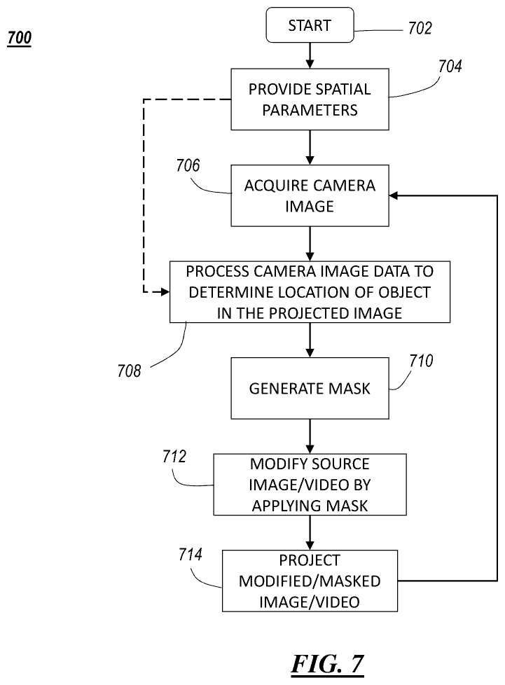

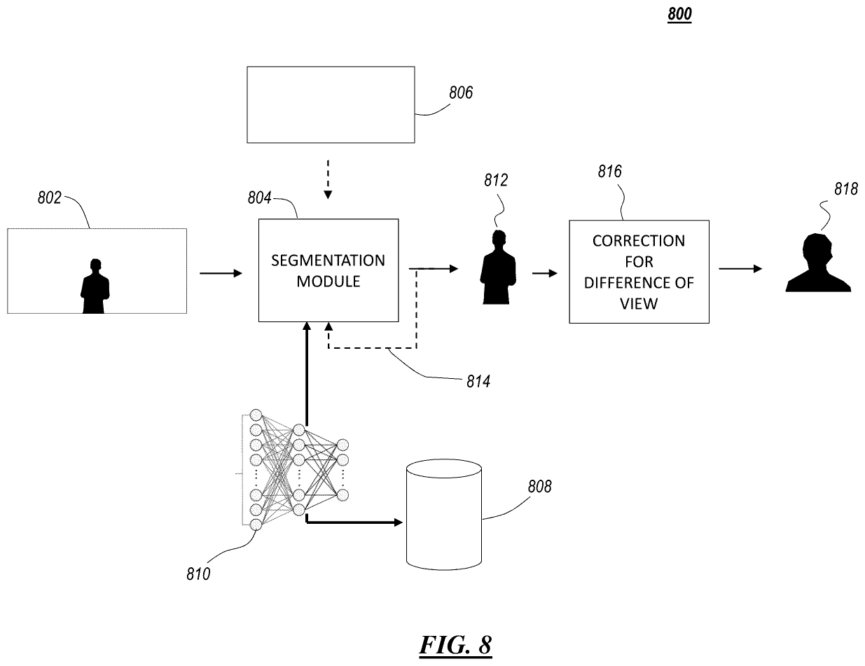

FIG. 7 shows a flowchart diagram of a method 700 for recognizing an object in a projected image field and generating a mask to change the light that is projected onto the object, in accordance with some embodiments. At the start 702 a projector, camera, and image processor, substantially as shown in FIG. 2 are provided. The projector projects light and can control the color of the light at points within an image field so that images (video) can be projected onto a surface for viewing by people. In step 704 the spatial relationship between the camera, the projector, and the projected image field are characterized so that the image processor can determine where in the image field of the projector that objects recognized in the camera view are located so that a mask or masks can be generated for those recognized objects. In step 706 the projector can begin projecting a source video, and the camera can begin acquiring image data of the projected image and of the space between the projection surface on which the source video is being projected and the projector. While in FIG. 2 the camera 210 is shown substantially displaced from the projector 202, the closer the camera is to the projector the more the camera view and the image field will correspond.

In step 708 the camera image data is processed to recognize objects in the image field of the projector. This step can include determining the position of the object in space relative to the projector. In step 710 a mask corresponding to the shape of the object and the location of the object in the image field of the projector is generated. In step 712 the mask is used to modify the source video being projected so that the light projected in the region of the mask is changed in step 714. The process of steps 706-714 are continuously repeated on an ongoing basis to recognize objects in the projected image field and to change the light projected onto the object from what would have been projected onto the object without modifying the source video.

FIG. 8 shows a detail of the object recognition and mask generation process 800, in accordance with some embodiments. Raw camera image data 802 includes a view of the image field in the space between some projection surface and the projector. The image data 802 can include an object that is at least partially in the image field. The image data can include a view of the area outside of the image field as well, but the image field location in the camera view is initially characterized and known. A segmentation module 804 can be used to process the image data 802 to recognize objects and determine where in the image field the objects are located. A database 808 can include object recognition models such as neural networks 810 that are used to process the image data and recognize objects in the image field. In some embodiments a frame 804 of the source video that is contemporaneous with the captured image data 802 may be used to compare with the image data 802 to identify objects in the image field. Once an object 812 is recognized the spatial data of the object 812 may be fed back 814 to the recognition process to enhance the recognition process going forward. That is, it can be assumed, for example, that an object recognized in one frame of image data is likely to be in about the same location in the next frame of image data produced by the camera. A correction process 816 then determines the portion of the recognized object and its position in the image field to generate a mask 818 that is then used to modify the source video to be projected. In some embodiments the generated mask 818 can be buffered and applied to a next frame of the source video to be projected so that a modified frame is then provided to the projector.

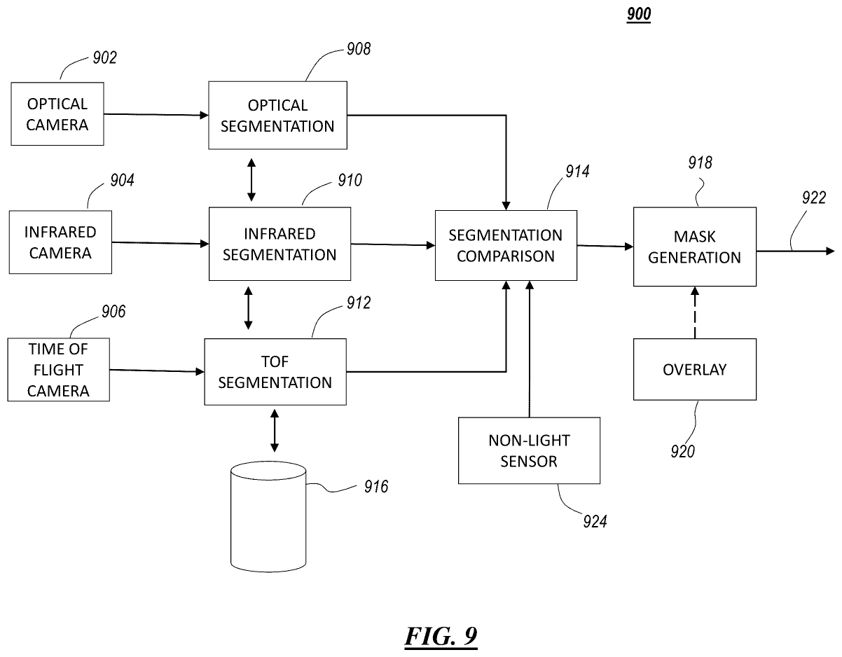

FIG. 9 shows a multi-camera system 900 for recognizing an object in a projected image field for generating a mask to change the light being projected on the object, in accordance with some embodiments. As mentioned hereinabove, multiple cameras can be used, as well as multiple camera types. For example, a conventional optical camera 902 can be used along with an infrared camera 904. Alternatively to the infrared camera 904, or in addition, a time of flight (TOF) or LIDAR camera 906 can be used. An infrared camera 904 can more easily identify objects in space between the projection surface and the projector than an optical (visible light) camera because the object temperature is likely to be more distinguishable from the temperature of the air around it, especially if the object is a person. The TOF camera 906 can be used to more accurately determine where, in the space between the projection surface and the projector, an object is located. The image data of each camera 902, 904, 906 can be processed by a corresponding segmentation function 908, 910, 912, respectively, that perform the object recognition for each camera 902, 904, 906. The recognition output can be shared among the different segmentation functions to augment each other. For example, the recognized object location produced by the infrared camera can be used to further train a neural network used to recognize objects in the optical camera image data. In block 914 the segmentation (recognition) outputs can be compared or correlated to identify the object location in the image field of the projector. Then a mask generation function 918 uses the recognition data to generate a mask output 922. An overlay 920 may be used in generating the mask output 922. A database 916 can be used to store the various recognition models as they are updated with further training.

It is further contemplated that another type of sensor 924 can be used to augment object detection and ranging. For example, radio and/or acoustic signals can be generated which are directed in toward the image field of the projector. The signal return can be detected and evaluated to determine a location and the space occupied by an object. As with camera systems, low power radio and acoustic wave generation and detection can be done using relatively small components.

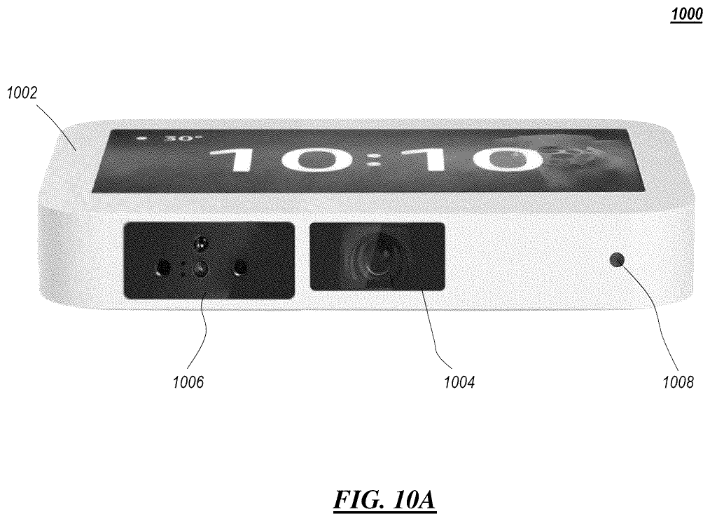

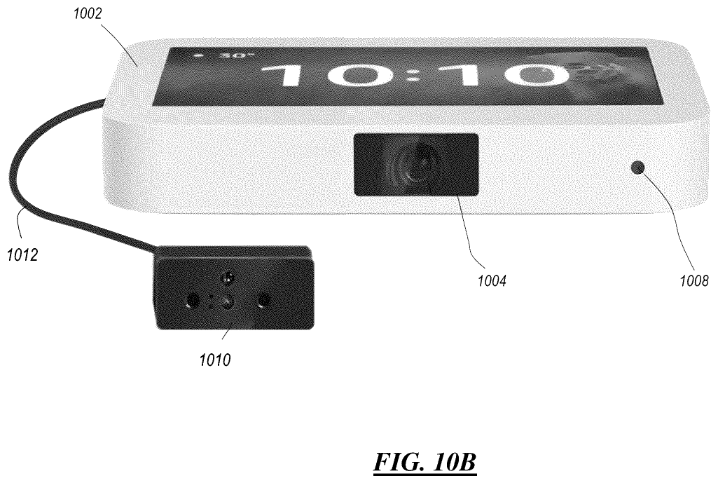

FIG. 10A shows a projection device 1000 that includes an integrated camera subsystem 1006 that detects objects in a projected image field of the projection device and which changes the light being projected onto the object by the projection device. The device 1000 includes a housing 1002 that houses all of the circuitry for powering the device 1000, as well as the projector subsystem 1004 and a camera subsystem 1006. The camera subsystem 1006 can include multiple cameras and multiple camera types, as exemplified in FIG. 9. If the camera subsystem 1006 includes a TOF camera, then an optical receiver 1008 will be present. The housing 1002 has conventional power and video-in connectors, and can have audio-out connectors on a back panel of the device (not in view here). These are conventional components typically provide on video projectors. The device 1000 operates as described herein; the camera subsystem 1006 generates image data from each camera's view. The image data of each camera is processed to recognize objects in the image field of the projector, and a mask or masks are generated to modify the source video being projected. FIG. 10B shows a similar projection device 1100 that also includes a housing 1002, projector 1004 and optical receiver 1008 that are integrated into the housing. However, the camera subsystem 1010 can be attached with a cable 1012 to the projector device housing 1002. In some embodiments, the projector device 1100 can be set up in a given position, and the camera subsystem 1010 can likewise be set up in another position. The projector 1004 can be used to project a test pattern or patterns that can be used by the camera subsystem 1010 to gauge the location of the camera subsystem 1010 relative to the projector 1004 to allow the projection device to properly map objects detected in the image field of the projector 1004.

The disclosed embodiments provide a projection system that can detect objects in the image field of the projector and generate a mask that modifies what is projected by the projector. In particular, the portion of the projected content that would have been projected onto the object is modified. The mask can be generated to have the shape of the object from the perspective of the projector so that only the light that is projected onto the object is modified. While camera systems have been described herein to identify objects in the image field, it is further contemplated that low power radio return and acoustic signal return can be used to identify objects in the image field of a projector to create a mask which modifies what is projected onto the object while it is in the image field.

The claims appended hereto are meant to cover all modifications and changes within the scope and spirit of the present invention.

1. A video projection system, comprising:
a projector that is configured to project a modified video onto a surface in an image field;
a camera having a camera view which includes the image field of the projector and that produces image data of the camera view;
a database in which a plurality of object recognition models is stored;
an image processor coupled to the projector and the camera, that recognizes an object in the image data that is in the image field of the projector by applying the image data to at least one of the object recognition models, and which generates a mask that is applied to a source video to create the modified video that is projected by the projector, wherein the projector changes light being projected in a region of the mask in the modified video, wherein the mask is generated using the at least one object recognition model to determine spatial data of the object in the camera view and by applying a correction to the spatial data, wherein the correction is based on determining a portion of the object and a position of the portion of the object in the image field of the projector.

2. The video projection system of claim 1, wherein the projector changes the light being projected in a region of the mask by reducing a brightness of the light being projected in the region of the mask relative to what would have been projected using the source video.

3. The video projection system of claim 2, wherein the light is blacked out in the region of the mask.

4. The video projection system of claim 1, wherein the projector changes the light being projected in a region of the mask by projecting a graphic overlay in the region of the mask instead of the portion of the source video that corresponds to the location of the mask in the image field.

5-6. (canceled)

7. The video projection system of claim 1, further comprising an infrared camera that captures an infrared image of the image field, wherein the object is recognized in the infrared image and used to further train at least one of the image recognition models.

8. The video projection system of claim 1, further comprising a time of flight camera.

9. The video projection system of claim 1, further comprising a non-light sensor that transmits a signal and senses a return signal that indicates a location of the object.

10. A video projection device, comprising:
a projector operable to project a modified video in an image field;
a sensor operable to generate an image that includes the projected image field of the projector;
a database in which a plurality of object recognition models is stored;
an image processor responsive to the sensor that is configured to process the image generated by the sensor, detect an object in the image field of the projector by applying the image to at least one of the plurality of object recognition models, and generate a mask corresponding to the object in the image field of the projector, wherein the mask is applied to a video source to produce the modified video that is projected by the projector wherein light in the region of the mask is modified from that of the video source, wherein the mask is generated using the at least one object recognition model to determine spatial data of the object in the camera view and by applying a correction to the spatial data, wherein the correction is based on determining a portion of the object and a position of the portion of the object in the image field of the projector.

11. The video projection device of claim 10, wherein the sensor is at least one camera.

12. The video projection device of claim 10, wherein the projector and the image processor are integrated into a housing.

13. The video projection device of claim 12, wherein the sensor is integrated into the housing.

14. The video projection device of claim 12, wherein the sensor is connected to the housing via a cable.

15. The video projection device of claim 10, wherein the sensor includes a non-light sensor.

16. A method of modifying a source video for projection, comprising:
identifying, using a camera, an image field of a projector that is projecting a video in a camera view of the camera;
detecting an object in the image field of the projector by capturing an image of the image field in the camera view using the camera and applying the image to at least one of a plurality of object recognition models;
determining a location of the object in the image field of the projector;
generating a mask that corresponds to the location of the object in the image field, wherein the mask is generated using the at least one object recognition model of the plurality of object recognition models to determine spatial data of the object in the image and by applying a correction to the spatial data, wherein the correction is based on determining a portion of the object and a position of the portion of the object in the image field;
applying the mask to a source video to produce a modified source video in which content in the region of the mask is modified; and
projecting the modified source video.

17. The method of claim 16, wherein detecting an object in the image field comprises detecting the object in an image taken by a camera that includes the image field and recognizing the object in the image field in the image taken by the camera.

18. The video projection system of claim 1, wherein the image processor is further configured to feed the spatial data of the object back to a recognition process to use the spatial data in a processing a next frame of image data.

19. The video projection system of claim 1, wherein the image processor is further configured to buffer the mask to be applied to a next frame of the source video.
